(19) United States
(12) Patent Application Publication
(10) Pub. No.: US 2026/0149931 A1
(43) Pub. Date: May 28, 2026

(54) HEAT DISSIPATION MODULE

(71) Applicant: AAC Microtech (Changzhou) Co., Ltd., Changzhou City (CN)

(72) Inventors: Zhang Ren, Changzhou (CN); Ronglin Linghu, Changzhou (CN); Yun Tang, Changzhou (CN)

(21) Appl. No.: 19/221,569

(22) Filed: May 29, 2025

Related U.S. Application Data
(63) Continuation of application No. PCT/CN2024/134246, filed on Nov. 25, 2024.

(51) Int. Cl. H04R 9/02; H04R 7/04; H04R 7/18; H04R 9/04; H04R 9/06

(52) U.S. Cl. CPC H04R 9/022; H04R 7/04; H04R 7/18; H04R 9/025; H04R 9/045; H04R 9/06; H04R 2400/11

(57) ABSTRACT

A heat dissipation module, including sound-producing device and vapor chamber connected to sound-producing device; sound-producing device includes frame, vibration unit fixed to frame, and magnetic circuit unit driving vibration unit to vibrate and produce sound; vapor chamber includes main body having inner cavity, capillary wick in inner cavity, opening provided on and passing through side of main body close to sound-producing device and connected to inner cavity, and heat dissipation liquid received in inner cavity; heat dissipation module further includes support member in annular shape, outer periphery of support member is attached and fixed to side of main body close to sound-producing device, inner periphery of support member is fixed to magnetic circuit unit. Vapor chamber of heat dissipation module can use vibration of magnetic circuit unit to push heat dissipation inside it to achieve active heat dissipation effect, thereby improving heat dissipation effect of heat dissipation module.

### TECHNICAL FIELD

The present disclosure relates to the technical field of electronic device and, in particular, to a head dissipation module of an electronic device with vibration and sound-producing functions.

### BACKGROUND

With the continuous development of electronic devices, people have always paid more attention to the heat dissipation of electronic devices such as mobile phones, tablets, and game consoles. The greater the power of the heating element of an electronic device, the higher the temperature it dissipates, which results in poor thermal reliability of the heating element.

As a heat dissipation element, the vapor chamber is thin and light. At the same time, due to its divergent steam path and good 2D surface thermal conductivity, its heat dissipation effect is better than that of the finned radiator. Applying the vapor chamber to electronic devices can avoid performance loss caused by poor heat dissipation of products.

In the related art, electronic devices generally have a sound-producing device that vibrates and produces sound, and a vapor chamber attached and fixed to the outer shell of the electronic device, which dissipates the heat generated by the heating element during operation through the vapor chamber.

The vapor chamber mainly includes a housing attached to the outer shell of the electronic device, a capillary wick formed in the housing, and a liquid working substance arranged in the capillary wick. When the electronic device is working, the VC vapor chamber inside it can only rely on gravity and capillary action for passive reflux after the water vapor condenses, which can easily lead to delayed reflux, causing “uniform temperature rise” inside the electronic device after long-term high-load operation, thus completely failing the convection and ultimately resulting in poor heat dissipation of the electronic device.

Therefore, there is an urgent need to provide a heat dissipation module to solve the above problems.

### SUMMARY

The object of the present disclosure is to provide a heat dissipation module to solve the problem that the vapor chamber of the electronic device in the related art can only perform passive heat dissipation, thereby resulting in poor heat dissipation effect of the electronic device.

In order to solve the above technical problems, an embodiment of the present disclosure provides a heat dissipation module, including a sound-producing device and a vapor chamber connected to the sound-producing device. The sound-producing device includes a frame, a vibration unit fixed to the frame, and a magnetic circuit unit driving the vibration unit to vibrate and produce sound.

The vapor chamber includes a main body having an inner cavity, a capillary wick received in the inner cavity, an opening provided on a side of the main body close to the sound-producing device and connected to the inner cavity, and a heat dissipation liquid received in the inner cavity.

The heat dissipation module further includes a support member in an annular shape and having elasticity, an outer periphery of the support member is attached and fixed to a side of the main body close to the sound-producing device, an inner periphery of the support member is fixed to the magnetic circuit unit, and the support member and the magnetic circuit unit jointly cover the opening to seal the inner cavity.

As an improvement, the support member includes a support portion in an annular shape and with an outer periphery thereof attached and fixed to the main body, and a first elastic connecting member fixed to an inner periphery of the support portion and having elasticity, and an inner periphery of the first elastic connecting member is attached and fixed to the magnetic circuit unit.

As an improvement, opposite sides of the support portion are provided with fixing portions protruding and extending toward a direction of the sound-producing device, and each of the fixing portions extends to the frame and forms a fixed connection with the frame. The support member further includes two second elastic connecting members having elasticity, and each of the second elastic connecting members is clamped and fixed between corresponding fixing portion and the magnetic circuit unit, respectively.

As an improvement, the capillary wick is arranged around the inner cavity and forms a loop in an annular shape, and the opening cuts off the capillary wick, in such a manner that the capillary wick forms two break ends on the loop thereof. The vapor chamber further includes a first one-way valve and a second one-way valve, the first one-way valve and the second one-way valve are arranged in the inner cavity, respectively, and the first one-way valve and the second one-way valve are arranged on opposite sides of the opening, respectively, to seal the two break ends.

As an improvement, the main body includes a bottom plate fixed to the support member and in an annular shape, a first bending portion formed by bending and extending from an outer periphery of the bottom plate, a second bending portion formed by bending and extending from an inner periphery of the bottom plate, and a top plate formed by bending and extending from a side of the first bending portion away from the bottom plate and connected to the second bending portion, and the bottom plate, the first bending portion, the second bending portion and the top plate are jointly enclosed to form the inner cavity. The opening is a notch of the bottom plate, the capillary wick forms a loop along a space between the bottom plate and the top plate, and the first one-way valve and the second one-way valve are arranged between the bottom plate and the top plate.

As an improvement, the heat dissipation module further includes a heat insulation film attached and fixed to a side of the magnetic circuit unit away from the vibration unit.

As an improvement, the support member is attached and fixed to a side of the main body close to the sound-producing device through a fixing member.

As an improvement, the magnetic circuit unit has a magnetic gap. The vibration unit includes a diaphragm fixed to the frame and a voice coil driving the diaphragm to vibrate. The diaphragm includes a vibration portion, a first folded ring portion formed by bending and extending from an outer periphery of the vibration portion, and a second folded ring portion in an annular shape and with an inner periphery thereof fixed to an outer periphery of the first folded ring portion, and an outer periphery of the second folded ring portion is fixed to the frame. The voice coil is fixed to the outer periphery of the first folded ring portion, and inserted and suspended in the magnetic gap.

As an improvement, the vibration unit further includes a framework and elastic members. The framework includes a connecting portion in an annular shape and an extending portion formed by bending and extending, toward a direction closer to the magnetic circuit unit, from two opposite outer sides of the connecting portion, an inner periphery of the connecting portion is fixed between the outer periphery of the first folded ring portion and the voice coil, respectively, and an outer periphery of the connecting portion is fixed to an inner periphery of the second folded ring portion. The elastic members include two extending portions fixed to the framework, respectively, each of the elastic members includes a first fixing arm fixed to a side of the frame away from the diaphragm, a second fixing arm fixed to corresponding extending portion, and two elastic arms formed by bending and extending, toward two ends of the second fixing arm, from the first fixing arm, the two elastic arms are fixedly connected to the second fixing arm, respectively, and the second fixing arm of one of the elastic members is electrically connected to the voice coil through a conductive member.

As an improvement, the magnetic circuit unit includes a lower clamping plate fixed to the frame, a main magnet stacked and fixed to a side of the lower clamping plate close to the vibration unit, and an auxiliary magnet stacked and fixed to the lower clamping plate and arranged around the main magnet, and the auxiliary magnet and the main magnet are spaced apart to form the magnetic gap. The support member is attached and fixed to a side of the lower clamping plate away from the vibration unit.

As an improvement, the magnetic circuit unit further includes an upper clamping plate stacked and fixed to a side of the main magnet away from the lower clamping plate, a first central magnet stacked and fixed to a side of the upper clamping plate away from the main magnet, a second central magnet stacked and fixed to a side of the first central magnet away from the upper clamping plate, and a side clamping plate stacked and fixed to a side of the auxiliary magnet away from the lower clamping plate, and the second central magnet is spaced apart from the vibration portion.

Compared with the related art, the heat dissipation module according to the present disclosure connects the main body of the vapor chamber and the magnetic circuit unit through the elastic support member, and the support member and the magnetic circuit unit jointly cover the opening of the vapor chamber to seal the inner cavity of the vapor chamber. In this way, when the heat dissipation module is working, the vibration unit can vibrate and produce sound, and transmit the vibration to the magnetic circuit unit through the elastic action of the support member, so that the vapor chamber can use the vibration of the magnetic circuit unit to push the heat dissipation liquid inside it to achieve the active heat dissipation effect, thereby improving the heat dissipation effect of the heat dissipation module. Meanwhile, the heat dissipation module according to the present disclosure only needs to extend the original vapor chamber in the electronic device to the position of the sound-producing device, thereby effectively utilizing the overall layout of the electronic device without adding extra installation space.

### BRIEF DESCRIPTION OF DRAWINGS

In order to clearly illustrate the technical solutions according to the embodiments of the present disclosure, the following briefly introduces the drawings required for describing the embodiments. It is appreciated that, the drawings described below are only some embodiments of the present disclosure, and those skilled in the art can obtain other drawings according to these drawings without creative efforts. In the drawings:

FIG. 1 is a three-dimensional structural schematic diagram of a heat dissipation module according to Embodiment 1 of the present disclosure.

FIG. 2 is a partial structural exploded view of a heat dissipation module according to Embodiment 1 of the present disclosure.

FIG. 3 is a cross-sectional view along line A-A in FIG. 1.

FIG. 4 is an enlarged structural view of portion C in FIG. 3.

FIG. 5 is a cross-sectional view along line B-B in FIG. 2.

FIG. 6 is a partial structural exploded view of a sound-producing device and a support member of a heat dissipation module according to Embodiment 1 of the present disclosure.

FIG. 7 is a three-dimensional structural schematic diagram of a heat dissipation module according to Embodiment 2 of the present disclosure.

FIG. 8 is a cross-sectional view along line D-D in FIG. 7.

FIG. 9 is an enlarged structural view of portion E in FIG. 8.

In the drawings, 100: heat dissipation module, 1: sound-producing device; 11: frame; 12: vibration unit; 121: diaphragm; 1211: vibration portion; 1212: first folded ring portion; 1213: second folded ring portion; 122: voice coil; 123: framework; 1231: connecting portion; 1232: extending portion; 124: elastic member; 1241: first fixing arm; 1242: second fixing arm; 1243: elastic arm; 1244: conductive member; 13: magnetic circuit unit; 131: lower clamping plate; 132: main magnet; 133: auxiliary magnet; 134: upper clamping plate; 135: first central magnet; 136: second central magnet; 137: side clamping plate; 14: elastic support member; 2: vapor chamber; 21: main body; 211: bottom plate; 212: first bending portion; 213: second bending portion; 214: top plate; 22: opening; 23: first one-way valve; 24: second one-way valve; 3: support member; 31: support portion; 32: first elastic connecting member; 33: fixing portion; 34: second elastic connecting member; 4: fixing member; 5: heat insulation film; 10: magnetic gap.

### DESCRIPTION OF EMBODIMENTS

The technical solutions according to the embodiments of the present disclosure will be described clearly and completely below in conjunction with the drawings according to the embodiments of the present disclosure. It is appreciated that, the described embodiments are only part of the embodiments of the present disclosure, rather than all the embodiments. According to the embodiments of the present disclosure, all other embodiments obtained by those skilled in the art without creative efforts shall fall within the protection scope of the present disclosure.

### Embodiment 1

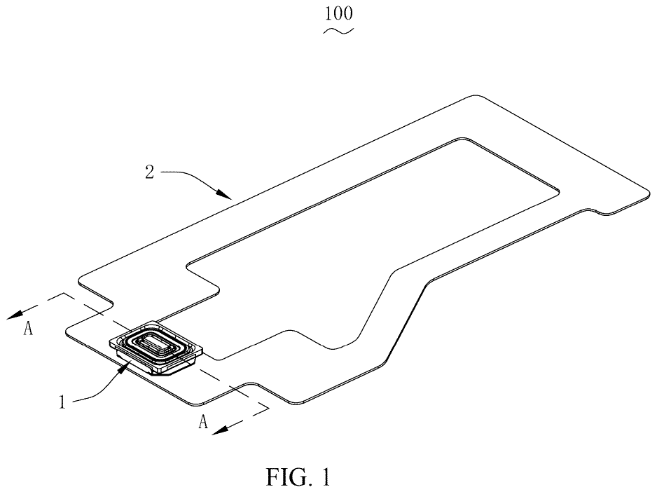

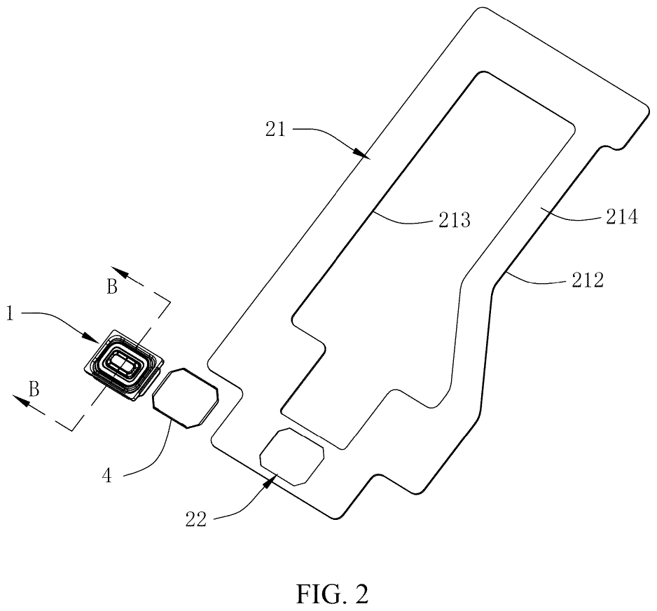

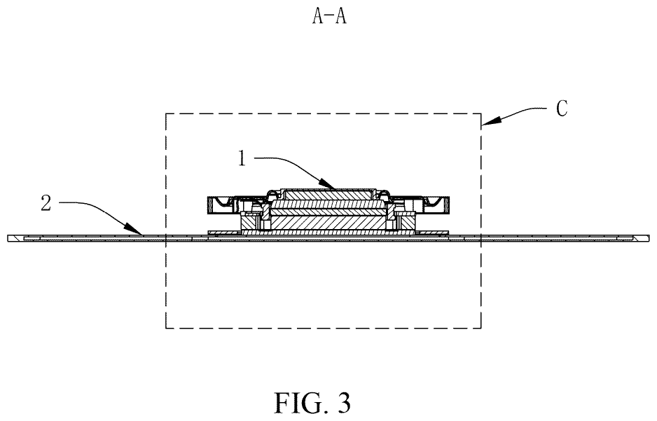

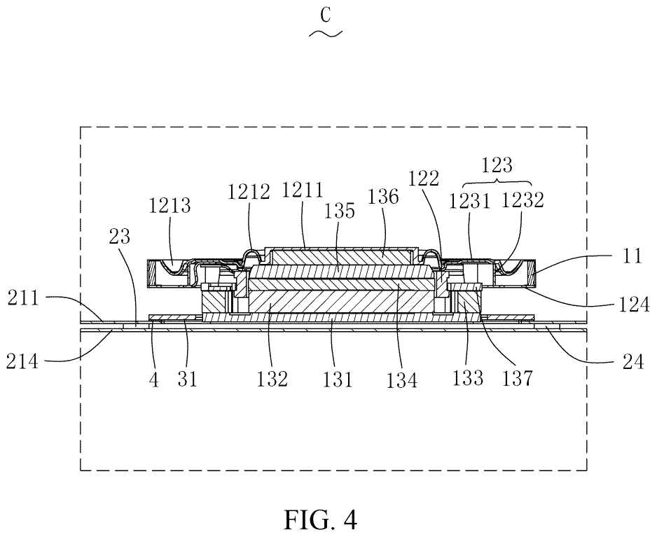

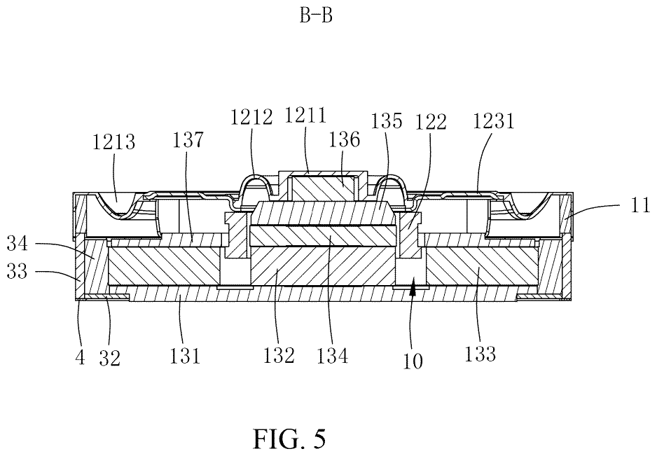

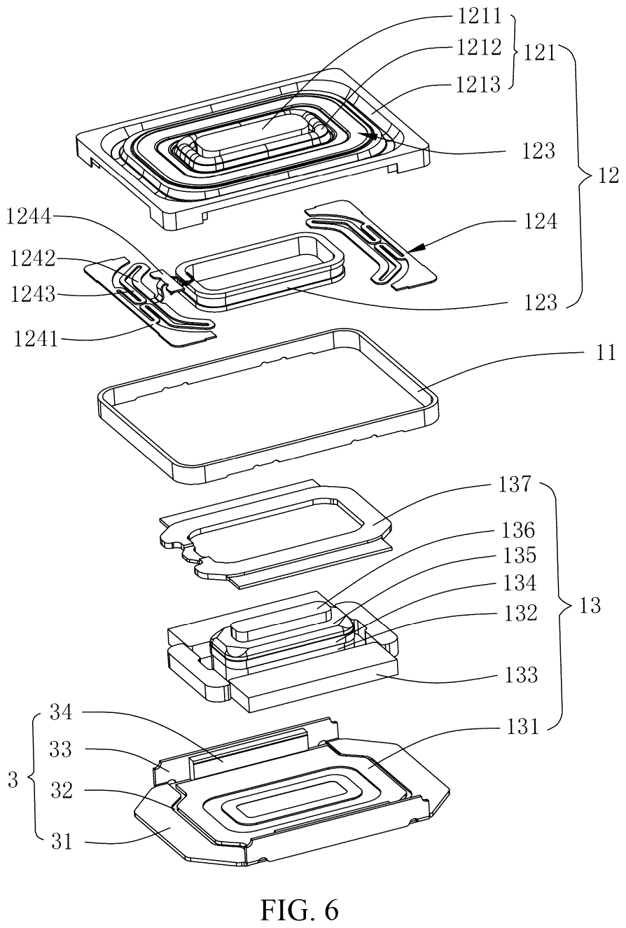

An embodiment of the present disclosure provides a heat dissipation module, as shown in FIG. 1 to FIG. 6, the heat dissipation module includes a sound-producing device 1 and a vapor chamber 2 connected to the sound-producing device 1. The sound-producing device 1 includes a frame 11, a vibration unit 12 fixed to the frame 11, and a magnetic circuit unit 13 driving the vibration unit 12 to vibrate and produce sound.

The vapor chamber 2 induces a main body 21 having an inner cavity, a capillary wick (not shown in the drawings) received in the inner cavity, an opening 22 provided on a side of the main body 21 close to the sound-producing device 1 and connected to the inner cavity, and a heat dissipation liquid received in the inner cavity. The capillary wick is arranged around the inner cavity and forms a loop in an annular shape, and the opening 22 cuts off the capillary wick, in such a manner that the capillary wick forms two break ends on the loop thereof.

In an embodiment, the vibration unit 12 includes a diaphragm 121 fixed to the frame 11 and a voice coil 122 driving the diaphragm 121 to vibrate.

The diaphragm 121 includes a vibration portion 1211, a first folded ring portion 1212 formed by bending and extending from an outer periphery of the vibration portion 1211, and a second folded ring portion 1213 in an annular shape and with an inner periphery thereof fixed to an outer periphery of the first folded ring portion 1212, and an outer periphery of the second folded ring portion 1213 is fixed to the frame 11. The voice coil 122 is fixed to the outer periphery of the first folded ring portion 1212.

The vibration unit 12 further includes a framework 123 and elastic members 124.

The framework 123 includes a connecting portion 1231 in an annular shape and an extending portion 1232 formed by bending and extending, toward a direction closer to the magnetic circuit unit 13, from two opposite outer sides of the connecting portion 1231, an inner periphery of the connecting portion 1231 is fixed between the outer periphery of the first folded ring portion 1212 and the voice coil 122, respectively, and an outer periphery of the connecting portion 1231 is fixed to an inner periphery of the second folded ring portion 1213.

The elastic members 124 include two extending portions 1232 fixed to the framework 123, respectively, each of the elastic members 124 includes a first fixing arm 1241 fixed to a side of the frame 11 away from the diaphragm 121, a second fixing arm 1242 fixed to corresponding extending portion 1232, and two elastic arms 1243 formed by bending and extending, toward two ends of the second fixing arm 1242, from the first fixing arm 1241, the two elastic arms 1243 are fixedly connected to the second fixing arm 1242, respectively, and the second fixing arm 1242 of one of the elastic members 124 is electrically connected to the voice coil 122 through a conductive member 1244.

The magnetic circuit unit 13 includes a lower clamping plate 131 fixed to the frame 11, a main magnet 132 stacked and fixed to the lower clamping plate 131 close to the vibration unit 12, and an auxiliary magnets 133 stacked and fixed to the lower clamping plate 131 and arranged around the main magnet 132, and the auxiliary magnets 133 and the main magnet 132 are spaced apart to form the magnetic gap 10. The voice coil 122 is inserted and suspended in the magnetic gap 10.

In an embodiment, the number of the auxiliary magnets 133 is four, which are arranged on the four side surfaces of the main magnetic 132, and the four auxiliary magnets 133 are arranged to be connected against each other in sequence. According to actual needs, the auxiliary magnets 133 can also be designed as an annular shape, or be arranged to correspond to two opposite sides of the main magnet 132, etc.

The magnetic circuit unit 13 further includes an upper clamping plate 134 stacked and fixed to a side of the main magnet 132 away from the lower clamping plate 131, a first central magnet 135 stacked and fixed to a side of the upper clamping plate 134 away from the main magnet 132, a second central magnet 136 stacked and fixed to a side of the first central magnet 135 away from the upper clamping plate 134, and a side clamping plate 137 stacked and fixed to a side of the auxiliary magnet 133 away from the lower clamping plate 131, and the second central magnet 136 is spaced apart from the vibration portion 1211.

In an embodiment, the heat dissipation module 100 further includes a support member 3 in an annular shape and having elasticity, an outer periphery of the support member 3 is attached and fixed to the side of the main body 21 close to the sound-producing device 1, an inner periphery of the support member 3 is fixed to the magnetic circuit unit 13, and the support member 3 and the magnetic circuit unit 13 jointly cover the opening 22 to seal the inner cavity. This design can transmit the vibration generated by the vibration unit 12 to the magnetic circuit unit 13 through the elastic effect of the support member 3, so that the vapor chamber 2 can use the vibration of the magnetic circuit unit 13 to push the heat dissipation liquid inside it to achieve the active heat dissipation effect.

The support member 3 includes a support portion 31 in an annular shape and with an outer periphery thereof attached and fixed to the main body 21, and a first elastic connecting member 32 fixed to an inner periphery of the support portion 31 and having elasticity, and an inner periphery of the first elastic connecting member 32 is attached and fixed to the magnetic circuit unit 13.

Opposite sides of the support portion 31 are provided with fixing portions 33 protruding and extending toward a direction of the sound-producing device 1, and each of the fixing portions 33 extends to the frame 11 and forms a fixed connection with the frame 11. The support member 31 further includes two second elastic connecting members 34 having elasticity, and each of the second elastic connecting members 34 is clamped and fixed between corresponding fixing portion 33 and the magnetic circuit unit 13, respectively. This design can enhance the elastic connection effect between the support member 3 and the magnetic circuit unit 13.

In an embodiment, the inner periphery of the first elastic connecting member 32 is attached and fixed to a side of the lower clamping plate 131 away from the vibration unit 12. In this case, the support portion 31, the first elastic connecting member 32 and the lower clamping plate 131 jointly cover the opening 22 to seal the inner cavity. Each of the second elastic connecting member 34 is clamped between a corresponding fixing portion 33 and a corresponding auxiliary magnet 133.

The main body 21 includes a bottom plate 211 fixed to the support member 3 and in an annular shape, a first bending portion 212 formed by bending and extending from an outer periphery of the bottom plate 211, a second bending portion 213 formed by bending and extending from an inner periphery of the bottom plate 211, and a top plate 214 formed by bending and extending from a side of the first bending portion 212 away from the bottom plate 211 and connected to the second bending portion 213, and the bottom plate 211, the first bending portion 212, the second bending portion 213 and the top plate 214 are jointly enclosed to form the inner cavity. The opening 22 is a notch of the bottom plate 211, and the capillary wick forms a loop along a space between the bottom plate 211 and the top plate 214. The structure of the main body 21 is not limited to the above description, and its structure can be designed according to the layout of the heating element of the electronic device.

In an embodiment, the outer periphery of the support portion 31 is attached and fixed to a side of the bottom plate 211 close to the sound-producing device 1.

The vapor chamber 2 further includes a first one-way valve 23 and a second one-way valve 24, the first one-way valve 23 and the second one-way valve 24 are arranged in the inner cavity, respectively, a flow direction of the first one-way valve 23 is the same as a flow direction of the second one-way valve 24, and the first one-way valve 23 and the second one-way valve 24 are arranged on opposite sides of the opening 22, respectively, to seal the two break ends. The first one-way valve 23 and the second one-way valve 24 are both arranged between the bottom plate 211 and the top plate 214. This design allows the heat dissipation liquid to circulate in the direction of the first one-way valve 23, the magnetic circuit unit 13 and the second one-way valve 24 in sequence, so that the heat dissipation liquid can take out the heat emitted by the sound-producing device 1 during the circulation process, and realize active heat dissipation through the vibration of the magnetic circuit unit 13, in such a manner to enhance the heat dissipation effect of the heat dissipation module 100. The heat dissipation liquid can also circulate in the direction of the second one-way valve 24, the magnetic circuit unit 13 and the first one-way valve 23 in sequence, and its function is the same as the above function, which will not be elaborated in the present disclosure.

The support member 3 is attached and fixed to the side of the main body 21 close to the sound-producing device 1 through a fixing member 4. That is, the fixing member 4 is attached and fixed between the support portion 31 and the bottom plate 211, respectively, which corresponds to the support portion 3 being indirectly fixed to the main body 21 through the fixing member 4. Since directly fixing the support member 3 to the main body 21 will result in poor stability, adding the fixing member 4 between the support member 3 and the main body 21 can improve the fixing effect between the support member 3 and the main body 21.

The vapor chamber 2 can be used with a single core or in combination with a BOX device. That is, the vapor chamber 2 can be used alone with a sound-producing device, or it can be used in combination with an electronic device with vibration and sound-producing functions, such as a speaker box, a mobile phone, a tablet, and a game console.

Compared with the related art, the heat dissipation module 100 according to the embodiment connects the main body 21 of the vapor chamber 2 and the magnetic circuit unit 13 through the elastic support member 3, and the support member 3 and the magnetic circuit unit 13 jointly cover the opening 22 of the vapor chamber 2 to seal the inner cavity of the vapor chamber 2. In this way, when the heat dissipation module 100 is working, the vibration unit 12 can vibrate and produce sound, and transmit the vibration to the magnetic circuit unit 13 through the elastic action of the support member 3, so that the vapor chamber 2 can use the vibration of the magnetic circuit unit 13 to push the heat dissipation liquid inside it to achieve the active heat dissipation effect, thereby improving the heat dissipation effect of the heat dissipation module 100. Meanwhile, the heat dissipation module 100 according to the embodiment only needs to extend the original vapor chamber 2 in the electronic device to the position of the sound-producing device 1, thereby effectively utilizing the overall layout of the electronic device without adding extra installation space.

### Embodiment 2

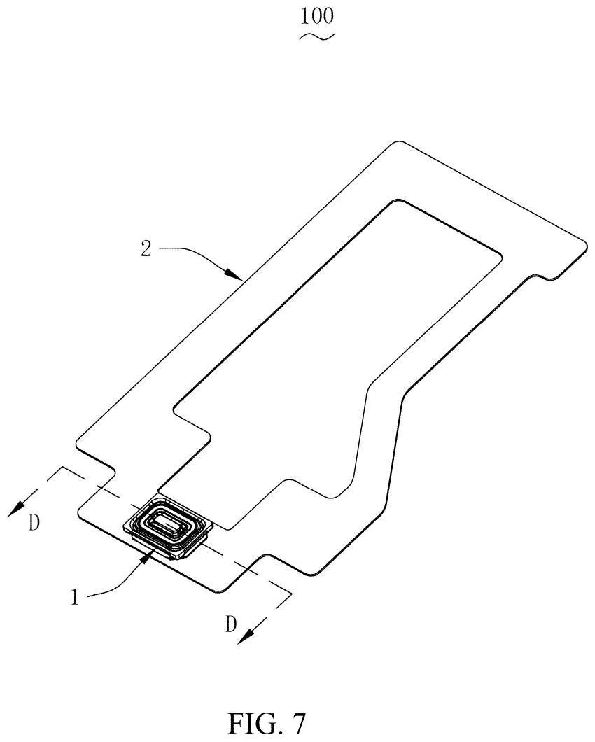

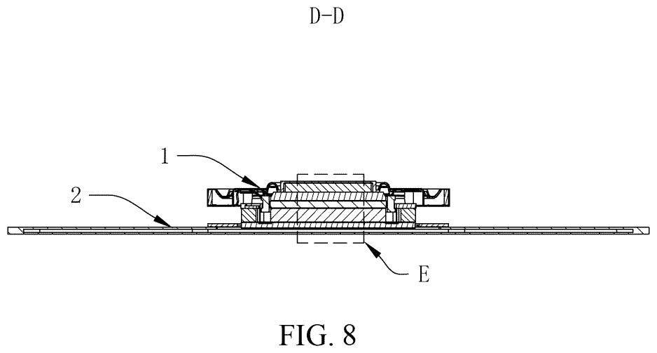

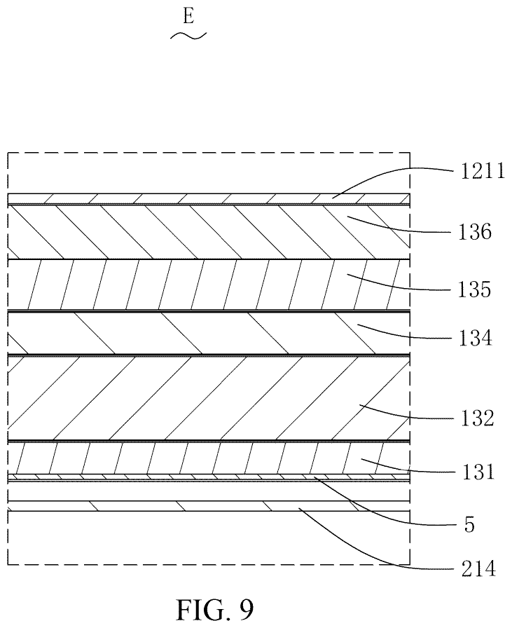

As shown in FIG. 7 to FIG. 9, the heat dissipation module 100 according to the embodiment of the present disclosure further includes a heat insulation film 5 attached and fixed to a side of the magnetic circuit unit 13 away from the vibration unit 12.

In an embodiment, the heat insulation film 5 is attached and fixed to a side of the lower clamping plate 131 away from the vibration unit 12. This design can prevent the working heat of the sound-producing device 1 from causing the temperature of the vapor chamber 2 to rise, and the heat insulation film 5 is determined whether to be provided according to the working heat of the sound-producing device 1 itself.

The above is only embodiments of the present disclosure. It should be pointed out that, for those skilled in the art, improvements can be made without departing from the creative concept of the present disclosure, but these all fall within the protection scope of the present disclosure.

What is claimed is:

1. A heat dissipation module, comprising a sound-producing device and a vapor chamber connected to the sound-producing device;
wherein the sound-producing device comprises a frame, a vibration unit fixed to the frame, and a magnetic circuit unit driving the vibration unit to vibrate to produce sound;
wherein the vapor chamber comprises a main body having an inner cavity, a capillary wick received in the inner cavity, an opening provided on a side of the main body close to the sound-producing device and connected to the inner cavity, and a heat dissipation liquid filled in the inner cavity; and
wherein the heat dissipation module further comprises a support member in an annular shape which has elasticity, an outer periphery of the support member is attached and fixed to a side of the main body close to the sound-producing device, an inner periphery of the support member is fixed to the magnetic circuit unit, and the support member and the magnetic circuit unit jointly cover the opening to seal the inner cavity.

2. The heat dissipation module as described in claim 1, wherein
the support member comprises a support portion in an annular shape which has an outer periphery attached and fixed to the main body, and a first elastic connecting member fixed to an inner periphery of the support portion and having elasticity,
wherein an inner periphery of the first elastic connecting member is attached and fixed to the magnetic circuit unit.

3. The heat dissipation module as described in claim 2, wherein
two opposite sides of the support portion each are provided with a fixing portion protruding and extending toward the sound-producing device, and each fixing portion extends to the frame and forms a fixed connection with the frame;
wherein the support member further comprises two second elastic connecting members having elasticity, and each of the second elastic connecting members is clamped and fixed between a corresponding fixing portion and the magnetic circuit unit, respectively.

4. The heat dissipation module as described in claim 1, wherein
the capillary wick is arranged around the inner cavity and forms a loop in an annular shape, and the opening cuts off the capillary wick, in such a manner that the capillary wick forms two break ends on the loop of the capillary wick;
wherein the vapor chamber further comprises a first one-way valve and a second one-way valve, the first one-way valve and the second one-way valve are arranged in the inner cavity, and the first one-way valve and the second one-way valve are arranged on two opposite sides of the opening, to seal the two break ends.

5. The heat dissipation module as described in claim 4, wherein
the main body comprises a bottom plate fixed to the support member and in an annular shape, a first bending portion formed by bending and extending an outer periphery of the bottom plate, a second bending portion formed by bending and extending an inner periphery of the bottom plate, and a top plate formed by bending and extending a side of the first bending portion away from the bottom plate and connected to the second bending portion,
wherein the bottom plate, the first bending portion, the second bending portion and the top plate jointly enclose and define the inner cavity; the opening is a notch formed at the bottom plate, the capillary wick forms a loop along a space between the bottom plate and the top plate, and the first one-way valve and the second one-way valve are arranged between the bottom plate and the top plate.

6. The heat dissipation module as described in claim 1, further comprising a heat insulation film attached and fixed to a side of the magnetic circuit unit away from the vibration unit.

7. The heat dissipation module as described in claim 1, wherein
the support member is attached and fixed to a side of the main body close to the sound-producing device through a fixing member.

8. The heat dissipation module as described in claim 1, wherein
the magnetic circuit unit has a magnetic gap; the vibration unit comprises a diaphragm fixed to the frame and a voice coil driving the diaphragm to vibrate;
wherein the diaphragm comprises a vibration portion, a first folded ring portion formed by bending and extending an outer periphery of the vibration portion, and a second folded ring portion in an annular shape and having an inner periphery fixed to an outer periphery of the first folded ring portion; an outer periphery of the second folded ring portion is fixed to the frame; and the voice coil is fixed to the outer periphery of the first folded ring portion, and inserted and suspended in the magnetic gap.

9. The heat dissipation module as described in claim 8, wherein
the vibration unit further comprises a framework and two elastic members; the framework comprises a connecting portion in an annular shape and an extending portion formed by bending and extending each of two opposite outer sides of the connecting portion toward the magnetic circuit unit,
wherein an inner periphery of the connecting portion is fixed between the outer periphery of the first folded ring portion and the voice coil, respectively, and an outer periphery of the connecting portion is fixed to an inner periphery of the second folded ring portion;
wherein the two elastic members comprise two extending portions fixed to the framework, respectively; and each of the two elastic members comprises: a first fixing arm fixed to a side of the frame away from the diaphragm, a second fixing arm fixed to a corresponding extending portion, and two elastic arms formed by bending and extending the first fixing arm toward two ends of the second fixing arm;
wherein the two elastic arms are fixedly connected to the second fixing arm, respectively, and the second fixing arm of one of the elastic members is electrically connected to the voice coil through a conductive member.

10. The heat dissipation module as described in claim 8, wherein
the magnetic circuit unit comprises a lower clamping plate fixed to the frame, a main magnet stacked and fixed to a side of the lower clamping plate close to the vibration unit, and an auxiliary magnet stacked and fixed to the lower clamping plate and arranged around the main magnet; the auxiliary magnet and the main magnet are spaced apart to form the magnetic gap; and the inner periphery of the support member is attached and fixed to a side of the lower clamping plate away from the vibration unit.

11. The heat dissipation module as described in claim 10, wherein
the magnetic circuit unit further comprises an upper clamping plate stacked and fixed to a side of the main magnet away from the lower clamping plate, a first central magnet stacked and fixed to a side of the upper clamping plate away from the main magnet, a second central magnet stacked and fixed to a side of the first central magnet away from the upper clamping plate, and a side clamping plate stacked and fixed to a side of the auxiliary magnet away from the lower clamping plate,
wherein the second central magnet is spaced apart from the vibration portion.
